(19) United States
(12) Patent Application Publication
(10) Pub. No.: US 2006/0114946 A1
(43) Pub. Date: Jun. 1, 2006

(54) Nonlinear crystal modifications for durable high-power laser wavelength conversion

(76) Inventors: Yunlong Sun, Beaverton, OR (US); Richard S. Harris, Portland, OR (US)

Correspondence Address: STOEL RIVES LLP, 900 SW FIFTH AVENUE, SUITE 2600, PORTLAND, OR, 97204-1268, US

(21) Appl. No.: 11/001,486

(22) Filed: Nov. 30, 2004

(51) Int. Cl. H01S 3/10

(52) U.S. Cl. 372/22; 372/21

(57) ABSTRACT

A wavelength converter (34) such as a nonlinear crystal has an angle cut exit surface (36) to separate a harmonic wavelength from a fundamental or different harmonic wavelength. A solid optical overlay medium (28) has an entrance surface (38) that is angle cut to mate with the converter exit surface (36). The optical overlay medium (28) is substantially transparent to the fundamental and selected harmonic wavelengths, has a refractive index similar to that of the wavelength converter (34), and has damage thresholds at the selected wavelengths that are greater than the respective damage thresholds of the wavelength converter (34).

### COPYRIGHT NOTICE

© 2004 Electro Scientific industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71 (d).

### TECHNICAL FIELD

The invention relates to high-power laser wavelength conversion and, in particular, to modifications of nonlinear crystals to facilitate durability.

### BACKGROUND OF THE INVENTION

Laser systems are employed in a variety of applications including communications, medicine, and micromachining. These applications utilize a variety of laser wavelengths and output powers. Unfortunately, available laser wavelengths are limited by the emission capabilities of a small number of laser media compositions that emit useful laser output at a relatively limited number of wavelengths.

The number of available laser wavelengths has been expanded through the use of a variety of wavelength conversion methods. These methods include the use of nonlinear crystals within or outside the laser cavity to provide harmonic wavelengths of the wavelength emitted by the laser media. KTP (potasium titanyle phosphate, KTiOPO₄), BBO (beta barium borate, beta-BaB₂O₄), and LBO (lithium triborate, LiB₃O₅) are the most commonly used nonlinear crystals for laser wavelength conversion. The properties of these crystals differ but they generally have large nonlinear optical coefficients, wide transparency and phase matching ranges, wide angular bandwidths and small walk-off angles, high optical homogeneity, and efficient frequency conversion.

Most nonlinear crystals also have disadvantages such as being hygroscopic and/or static or having barely satisfactory damage thresholds. Antireflective (AR) coatings or other coatings are typically applied onto the crystal surfaces to reduce losses. The coatings also protect the crystals from moisture or other contamination. Unfortunately, coating nonlinear crystals is more difficult than coating traditional optical materials such as fused silica, sapphire, and YAG, etc., mainly due to the material nature of the nonlinear crystals. Coatings on nonlinear crystals are also susceptible to optical damage particularly in high power and/or ultraviolet (UV) wavelength applications.

In U.S. Pat. No. 5,850,407 of Grossman et al., tripling LBO crystals are provided with an uncoated Brewster angle-cut dispersive output surface for separating polarized fundamental and third-harmonic beams without introducing significant losses. The uncoated output surface of the third-harmonic crystal is somewhat insensitive to potential ultraviolet-induced damage and enhanced durability.

In U.S. Pat. No. 6,697,391 of Grossman et al., quadrupling crystals are provided with an uncoated Brewster angle-cut dispersive output surface for separating polarized fundamental and fourth-harmonic beams without introducing significant losses. The uncoated output surface of the fourth-harmonic crystal is somewhat insensitive to potential ultraviolet-induced damage and provides enhanced durability. Many industrial applications demand substantially damage-free operation (<0.1% damage-induced losses) for thousands of hours (typically >10,000 hours) at high power levels (peak powers from 10⁷ to greater than 10⁹ W/cm² for a 150 μm spot size).

Nevertheless, due to the very static nature of the crystal, there is a noticeable contamination risk to the bared LBO surface and other bared frequency (or wavelength) converting crystal surfaces. Contamination of the surface reduces the damage threshold of the crystal significantly, particularly at high UV power, and surface damage compromises UV power stability. Many frequency conversion crystals are also hygroscopic in nature and can absorb moisture in the atmosphere, thereby over time degrading and ultimately causing laser damage to the crystal surface. So coatings for some of these frequency conversion crystals may be desirable.

### SUMMARY

An object of the present invention is, therefore, to provide an improved means for laser wavelength conversion.

In one embodiment, a wavelength converter such as a nonlinear crystal has exit surface cut at an angle to optical axis of the propagating fundamental wavelength to separate a harmonic wavelength. A solid optical overlay has an entrance surface that is also cut at an angle to mate with the wavelength converter exit surface and is optically connected to the wavelength converter. In some embodiments, the optical overlay is generally substantially transparent to the harmonic wavelength, has a refractive index similar to that of the wavelength converter, and has damage thresholds at the fundamental and/or harmonic wavelengths that are greater than that of the wavelength converter.

Additional aspects and advantages will be apparent from the following detailed description of preferred embodiments, which proceeds with reference to the accompanying drawings.

### BRIEF DESCRIPTION OF THE DRAWINGS

FIG. 1 is a schematic diagram of a laser employing a compound optical element for laser wavelength conversion.

FIG. 2 is a side elevation view of an embodiment of a compound optical element for laser wavelength conversion.

FIG. 3 is a side elevation view of an alternative embodiment of a compound optical element for laser wavelength conversion.

FIG. 4 is a side elevation view of another alternative embodiment of a compound optical element for laser wavelength conversion.

### DETAILED DESCRIPTION OF PREFERRED EMBODIMENTS

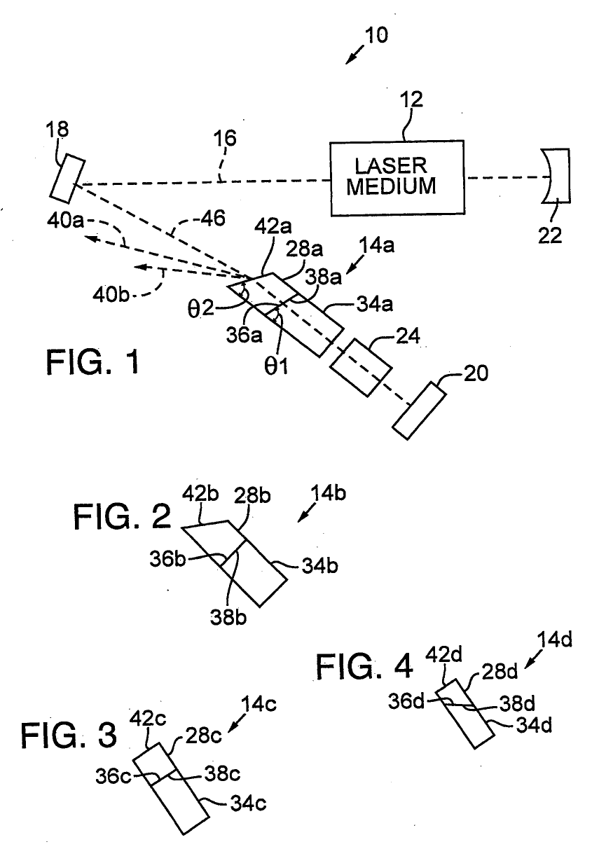

FIG. 1 is a schematic diagram of an embodiment of a laser 10 employing a laser medium 12 and a compound wavelength-converting element 14a (generically, compound wavelength-converting element 14) positioned along an optical path 16 that reflects off a fold mirror 18 and end mirrors 20 and 22. The laser medium 12 preferably comprises a conventional solid-state lasant such as YAG, YLF, YVO₄, YALO, sapphire, alexandrite, or CrLiSAF compositions and preferably produces laser radiation or laser energy having an infrared (IR) fundamental wavelength. Such compositions are typically doped with Nd, Yb, Er, Cr, or Tm. Typical fundamental laser IR wavelengths include, but are not limited to, 750-800 nm, 1064 nm, 1047 nm, and 1320 nm. Skilled persons will appreciate, however, that a variety of other wavelengths, such as visible wavelengths, and other laser media or types of lasers could be employed including, but not limited to, a gas, CO₂, excimer, or copper vapor laser. Solid-state laser media is preferably pumped by a diode laser or diode laser array, but any conventional laser pumping device or laser pumping scheme can be employed.

In one embodiment, a first wavelength converter 24 converts some or all of the laser radiation at the fundamental, or first harmonic, wavelength propagating along the optical path 16 into laser radiation having a second harmonic wavelength. The first wavelength converter 24 preferably comprises a nonlinear crystal, including but not limited, to a composition comprising BBO, BIBO (bismuth triborate, BiB₃O₆), LilO₃ (lithium iodate), LiNbO₃ (lithium niobate), LBO, KDP (potassium dihydrogen phosphate KH₂PO₄), KTA (potasium titanyle arsenate, KTiOAsO₄), KTP, AgGaS₂ (silver gallium sulfide), AgGaSe₂ (silver gallium selenite), or derivatives thereof, but may comprise other wavelength converting material.

An antireflective coating may optionally be applied to the first wavelength converter 24, and/or the first wavelength converter 24 may optionally be optically connected to a solid optical overlay medium 28a (generically, solid optical overlay medium 28) as later described.

The compound wavelength-converting element 14 includes a second wavelength converter 34a (generically, second wavelength converter 34) that is optically connected to a solid optical overlay medium 28. In general embodiments, the second wavelength converter 34 converts laser radiation having a harmonic wavelength (including but not limited to the first, second, or third harmonic) or a combination of one or more of them into laser radiation having one or more selected harmonic wavelengths (including but not limited to the second, third, fourth or fifth harmonic). In one embodiment, the second wavelength converter 34 converts laser radiation having the second harmonic wavelength into laser radiation having a fourth harmonic wavelength. In another embodiment, the second wavelength converter 34 converts laser radiation having the first and second harmonic wavelengths into laser radiation having a third harmonic wavelength. The second wavelength converter 34 may comprise the same or different nonlinear-crystal or other wavelength-converting material of the first wavelength converter 24. These wavelength converting materials have respective damage thresholds at the selected harmonic wavelengths.

The solid optical overlay medium 28 comprises an optical material that has damage thresholds at the fundamental and one or more of the selected harmonic wavelengths that are preferably higher than the respective damage thresholds of the second wavelength converter 34 and/or its antireflective coating. Alternatively, the solid optical overlay medium 28 employs an antireflective coating that has better properties and/or damage thresholds at the fundamental and one or more of the selected harmonic wavelengths than those the respective properties and/or damage thresholds of the antireflective coating of the second wavelength converter 34.

The solid optical overlay medium 28 comprises an optical material that is preferably substantially transparent to the fundamental and one or more of the selected harmonic wavelengths.

The solid optical overlay medium 28 also preferably has indices of refraction, at the fundamental and one or more of the selected harmonic wavelengths, that are similar to the respective indices of refraction of the second wavelength converter 34. In general, at the selected wavelengths, refractive indices that are within about two tenths of a refractive index point should be considered to be similar. Skilled persons will appreciate, however, that the closest respective refractive indices between the solid optical overlay medium 28 and the second wavelength converter 34 are most preferred to minimize loss at the interface between output surface 36 and mated surface 38 when a normal angle is used as illustrated in FIGS. 2 and 3, absent other considerations such as respective damage thresholds. Skilled persons will also appreciate that when the respective refractive indices are intentionally different or not well matched, the Brewster angle between the second wavelength converter 34 and the selected optical overlay medium 28 can be calculated and fabricated to minimize the reflection loss at the interface, as illustrated in FIGS. 1 and 4.

In some embodiments, an output surface 36a (generically, output surface 36) of the second wavelength converter 34 and a mated surface 38a (generically, mated surface 38) of the solid optical overlay medium 28 are optically connected against each other mechanically, such as with guides and clamps. In some embodiments, the output surface 36 and the mated surface 38 are optically connected by any appropriate known diffusion bonding technique. In some preferred diffusion bonding techniques, the output surface 36 and the mated surface 38 are cut at mated angles and polished to an optical quality flatness that is typically better than the selected harmonic wavelengths. The output surface 36 and the mated surface 38 are then pressed together at an appropriate pressure at a bonding temperature for a sufficient amount of time. In some diffusion bonding techniques, the bonding temperature is typically at least 50%-70% of the melting temperature of at least one of the second wavelength converter 34 or the solid optical overlay medium 28; the bonding pressure is in the range of a few pounds per square centimeter; and the heat is applied for a few hours. Diffusion bonding techniques, as well as other optical contact joining techniques, are well known in the optics industry, and bonding the various combinations of wavelength converting materials to solid optical overlay materials should not be difficult for skilled practitioners. Exemplary solid optical overlay media 28 include, but are not limited to, undoped YAG, sapphire, ruby, fused silica, quartz, and ED-2, ED-4, E-Y1 from Owens in Illinois, or the like.

In embodiments exemplified by FIG. 1, the second wavelength converter 34a has an output surface 36a and the solid optical overlay medium 28a has an output surface 42a (generically output surface 42) that are cut at approximately the same angles of θ₁ and θ₂, or different angles θ₁ and θ₂ to direct harmonic laser outputs 40a and 40b (generically harmonic laser output 40) out of laser 10. Accordingly, if angles of θ₁ and θ₂ are the same non-normal angle, the solid optical overlay medium 28a has a side view profile of a parallelogram. In some embodiments, the angles θ₁ and θ₂ are generally between 20 degrees and 90 degrees to an optical axis 46 of the optical path 16 between the mirrors 18 and 20.

In some preferred embodiments, the angle θ₁ can be determined by the Brewster angle for the interface between the second wavelength converter 34 and the solid optical overlay medium 28 at the fundamental laser wavelength. If one assumes that the refractive index of the solid optical overlay medium 28 is n₁ and the refractive index of the second wavelength converter 34 at the fundamental wavelength for the selected polarization is n₂, then the Brewster angle θ_{b} is determined by:
θ_{b}=Arctan(n₂/n₁) (1).

Then, θ₁ is determined by:
θ₁=90−ArcSin[(n₁×Sin θ_{b})/n₂] (2).

This selected adaptation will enable the laser beam to traverse the compound optical element 14 along a path that is substantially parallel to the side of the compound optical element 14.

θ₂ can be determined by the same formula, with the n₁ being the refractive index of air (n₁=1), and n₂ being the refractive index of the solid optical overlay medium 28.

The polarization of the fundamental laser wavelength is preferably linear and in the plane defined by the optical axis and the normal to the external surface of the solid optical overlay medium 28. One preferred harmonic generation scheme is that the third harmonic has the same linear polarization as the fundamental. This arrangement will obviate the need for any optical anti-reflection coating for the fundamental laser radiation as the optical loss due to reflection will be substantially zero at both the interfaces of between the air and the solid optical overlay medium 28 and between the solid optical overlay medium 28 and the second wavelength converter 34. The refractive index at the third harmonic will be different from that at the fundamentals, so the exact Brewster angle at the third harmonic will be different from the Brewster angle at the fundamental. However, this difference is very small, so the third harmonic with the same polarization as that of the fundamental will be subject to a very minimum loss at the two Brewster angled interfaces, while the index difference ensures adequate angular separation between the harmonics from the fundamental.

FIG. 2 is a side elevation view of alternative embodiments of a compound optical element 14b having a wavelength converter 34b with its output surface 36b and the mated surface 38b of the solid optical overlay medium 28b being generally perpendicular to the optical axis 46. The output surface 42b has, however, an angle θ as described above.

FIG. 3 is a side elevation view of alternative embodiments of a compound optical element 14c having a wavelength converter 34c with its output surface 36c and the mated surface 38c of the solid optical overlay medium 28c being generally perpendicular to the optical axis 46. The output surface 42b is also generally perpendicular to the optical axis 46, and in some embodiments, is covered by an antireflective coating. Embodiments of compound optical elements 14c can be employed in laser systems 10 where one of the mirrors 18 or 20 is an output coupling mirror for the desired harmonic wavelength, such as the third harmonic.

FIG. 4 is a side elevation view of alternative embodiments of a compound optical element 14d having a wavelength converter 34d with its output surface 36d being cut at an angle θ₁ as described above and the mated surface 38d of the solid optical overlay medium 28d being cut at a generally mated angle. The output surface 42d is generally perpendicular to the optical axis 46, and in some embodiments, is covered by an antireflective coating. Embodiments of compound optical elements 14d can be employed in laser systems 10 where one of the mirrors 18 or 20 is an output coupling mirror for the desired harmonic wavelength, such as the third harmonic.

In one example, the second wavelength converter 34 comprises KDP, KD*P, BBO, BIBO, LilO₃, KTA, KTP or LBO or derivatives thereof and the solid optical overlay medium 28 comprises fused silica, quartz, undoped YAG, sapphire, ED-2, ED-4, or E-Y1.

In some embodiments, angle O₁ is selected as a 90 degree angle as illustrated in FIGS. 2 and 3. To reduce or minimize reflection loss at the interface of the solid optical overlay medium 28 and the wavelength converter 34, the refractive index of the solid optical overlay medium 28 should be preferably closely matched to that of wavelength converter 34. As an example of a common material for a wavelength converter 34, LBO has a refractive index of approximately 1.60 at the fundamental wavelength of 1.06 micron. Accordingly, potential material for the solid optical overlay medium 28 would be the laser glass ED-2, which has a corresponding index of approximately 1.555. For this example, the optical loss due to reflection at the interface is approximately 0.02%. In another example for a fundamental wavelength of 1.06 micron, a solid optical overlay medium 28 of BBO would be combined with a solid optical overlay medium 28 of optical quality sapphire. In this example, the refractive indices are approximately 1.655 and 1.755 respectively, and the predicted single pass reflection loss is approximately 0.09%. These reflection losses should be acceptable even inside a typical laser cavity.

In embodiments where O₁ is selected based on the formulas of equations (1) ands (2), then the selection of the solid optical overlay medium 28 will be more governed by the combination of its refractive index, which will affect the Brewster angles and the separation angles of the harmonics from the fundamental, its damage threshold, the damage threshold of coating on the material if a coating is chosen, and the easiness of optical fabrication, etc. Skilled persons will appreciate that the damage thresholds of optical coatings for respective optical materials typically parallel the relative damage thresholds of the respective optical materials, as well as relate to the practically realizable quality of optical surface preparation of the respective optical materials. So, optical coatings for the solid optical overlay media 28 will generally have much higher damage thresholds than optical coatings for the respective wavelength converters 34. High damage threshold antireflective or other optical coatings for the solid optical overlay media 28 are well known to skilled practitioners.

It will be obvious to those having skill in the art that many changes may be made to the details of the above-described embodiments without departing from the underlying principles of the invention. The scope of the present invention should, therefore, be determined only by the following claims.

1. A harmonic laser, comprising:
a laser medium positioned within a laser resonator along an optical path and adapted to facilitate generation of laser radiation having a first wavelength;
a wavelength converting medium positioned along the optical path and adapted for converting a percentage of the laser radiation from the first wavelength, one of its harmonics, or combinations of them to a second wavelength that is harmonically related to the first wavelength, the wavelength converting medium having damage thresholds at the first and second wavelengths and a converter exit surface with a converter exit surface angle relative to an axis of the optical path entering the wavelength converting medium; and
a solid optical overlay medium optically connected to the converter exit surface of the wavelength converting medium and having an overlay entrance surface with an overlay entrance surface angle that mates with the converter exit surface angle, the solid optical overlay medium being substantially transparent to the first and second wavelengths and having damage thresholds at the first and second wavelengths that are greater than the respective damage thresholds of the wavelength converting medium.

2. The harmonic laser of claim 1 in which the converter exit surface angle is greater than a zero degree angle and less than or equal to a 90 degree angle.

3. The harmonic laser of claim 1 in which the converter exit surface angle is less than a 90 degree angle and functions to separate the laser radiation having the second wavelength from the laser radiation having the first wavelength.

4. The harmonic laser of claim 1 in which the converter exit surface angle is from about a 20 degree angle to about a 90 degree angle relative to the axis of the optical path entering the wavelength converting medium.

5. The harmonic laser of claim 1 in which the wavelength converting and optical overlay media have similar indices of refraction.

6. The harmonic laser of claim 1 in which the wavelength converting medium comprises AgGaS₂, AgGaSe₂, BBO, BIBO, KTA, KTP, KDP, KD*P/KDP, LiNbO₃, LiLO₃, LBO, or their derivatives.

7. The harmonic laser of claim 1 in which the solid optical overlay medium comprises fused silica, quartz, undoped YAG, sapphire, ED-2, or ED-4, or E-Y1.

8. The harmonic laser of claim 1 in which the solid optical overlay medium is diffusion bonded to the wavelength converting medium.

9. The harmonic laser of claim 1 in which the solid optical overlay medium comprises an overlay exit surface angle at about a Brewster angle and is adapted for propagating radiation at the first and second wavelengths without an antireflective coating.

10. The harmonic laser of claim 1 in which the second wavelength comprises an ultraviolet wavelength.

11. The harmonic laser of claim 1 in which the wavelength converting and solid optical overlay media have different indices of refraction.

12. The harmonic laser of claim 1 in which the solid optical overlay medium and the wavelength converting medium are mechanically held against each other.

13. The harmonic laser of claim 1 in which the optical overlay medium comprises an overlay exit surface with an antireflective coating adapted for propagating the laser radiation at the first and second wavelengths.

14. The harmonic laser of claim 1 in which the wavelength converting medium is positioned within the laser resonator.

15. The harmonic laser of claim 1 in which the wavelength converting medium is positioned externally to the laser resonator.

16. The harmonic laser of claim 1 in which the laser medium comprises a solid-state laser crystal, or contents of a discharge chamber of an excimer laser, a CO₂ laser, or a copper vapor laser.

17. The harmonic laser of claim 1 in which the laser medium comprises YAG, YLF, YVO₄, YALO, or CrLiSAF compositions.

18. The harmonic laser of claim 1 in which the second wavelength comprises a second harmonic, third harmonic, fourth harmonic, or fifth harmonic wavelength.

19. The harmonic laser of claim 9 in which the second wavelength comprises an ultraviolet wavelength.

20. The harmonic laser of claim 1 in which the laser radiation at the second wavelength is employed for micromachining.

21. The harmonic laser of claim 1 in which the laser radiation at the second wavelength is employed for via drilling or wafer dicing.

22. The harmonic laser of claim 1 in which the laser resonator has an end mirror that functions as an output coupler and that is adapted to separate the laser radiation having the second wavelength from the laser radiation having the first wavelength.

23. The harmonic laser of claim 1 in which the optical overlay medium comprises an overlay exit surface with an optical coating adapted for propagating the laser radiation at the first and second wavelengths, the coating having damage thresholds at the respective first an second wavelengths that are greater than respective damage thresholds of typical optical coatings applied to the wavelength converting medium.

24. The harmonic laser of claim 1 in which the solid optical overlay medium comprises an overlay exit surface angle that is about the same as the converter exit surface angle.

25. The harmonic laser of claim 1 in which the solid optical overlay medium comprises an overlay exit surface angle that is significantly different from the converter exit surface angle.

26. A compound optical element, comprising:
a wavelength converting medium adapted for converting a percentage of laser radiation from a first wavelength, one of its harmonics, or a combination of them to a second wavelength that is harmonically related to the first wavelength, the wavelength converting medium having an entrance surface suited for receiving laser radiation propagating along an optical path, the wavelength converting medium having damage thresholds at the first and second wavelengths and a converter exit surface with a converter exit surface angle relative to an axis of the optical path entering the wavelength converting medium; and
a solid optical overlay medium optically connected to the converter exit surface of the wavelength converting medium and having an overlay entrance surface with an overlay entrance surface angle that mates with the converter exit surface angle, the optical overlay medium being relatively transparent to the first and second wavelengths, having a refractive index similar to that of the wavelength converting medium at the second wavelength, and having a damage threshold at the second wavelength that is greater than the damage threshold of the wavelength converting medium at the second wavelength.

27. The compound optical element of claim 26 in which the converter exit surface angle is from about a 20 degree angle to a 90 degree angle relative to the axis of the optical path entering the wavelength converting medium.

28. The compound optical element of claim 26 in which the converter exit surface angle is less than a 90 degree angle and is adapted to separate the laser radiation having the second wavelength from the laser radiation having the first wavelength.

29. The compound optical element of claim 28 in which the wavelength converting medium comprises AgGaS₂, AgGaSe₂, BBO, BIBO, KTA, KTP, KDP, KD*P/KDP, LiNbO₃, LiLO₃, or LBO.

30. The compound optical element of claim 29 in which the solid optical overlay medium comprises fused silica, quartz, undoped YAG, sapphire, ED-2, or ED-4, or E-Y1.

31. The compound optical element of claim 26 in which the wavelength converting medium comprises AgGaS₂, AgGaSe₂, BBO, BIBO, KTA, KTP, KDP, KD*P/KDP, LiNbO₃, LiLO₃, or LBO.

32. The compound optical element of claim 31 in which the solid optical overlay medium comprises fused silica, quartz, undoped YAG, sapphire, ED-2, or ED-4, or E-Y1.

33. The compound optical element of claim 32 in which the optical overlay medium is diffusion bonded to the wavelength converting medium.

34. The compound optical element of claim 33 in which the second wavelength comprises an ultraviolet wavelength.

35. The compound optical element of claim 33 in which the solid optical overlay medium comprises an overlay exit surface angle that is about the same as the converter exit surface angle.

36. The compound optical element of claim 33 in which the solid optical overlay medium comprises an overlay exit surface angle that is significantly different from the converter exit surface angle.

37. The compound optical element of claim 26 in which the solid optical overlay medium comprises an overlay exit surface angle that is about the same as the converter exit surface angle.

38. The compound optical element of claim 26 in which the solid optical overlay medium comprises an overlay exit surface angle that is significantly different from the converter exit surface angle.

39. The compound optical element of claim 26 in which the optical overlay medium is diffusion bonded to the wavelength converting medium.

40. The compound optical element of claim 26 in which the solid optical overlay medium comprises fused silica, quartz, undoped YAG, sapphire, ED-2, or ED-4, or E-Y1.

41. The compound optical element of claim 40 in which the optical overlay medium is diffusion bonded to the wavelength converting medium.

42. The compound optical element of claim 26 in which the solid optical overlay medium comprises an overlay exit surface angle at about a Brewster angle and is adapted for propagating radiation at the first and second wavelengths without an antireflective coating.

43. The compound optical element of claim 26 in which the solid optical overlay medium comprises an overlay exit surface with an optical coating adapted for propagating laser radiation at the first and second wavelengths, the coating having damage thresholds at the respective first an second wavelengths that are greater than respective damage thresholds of typical optical coatings applied to the wavelength converting medium.

44. A method of generating harmonic laser output, comprising:
supplying pumping power to a laser medium;
employing the laser medium to generate laser radiation having a first wavelength propagating along an optical path;
employing a wavelength converting medium to convert a percentage of the laser radiation from a first wavelength, one of its harmonic, or a combination of them to a second wavelength that is harmonically related to the first wavelength, the wavelength converting medium having damage thresholds at the first and second wavelengths and a converter exit surface with a converter exit surface angle relative to an axis of the optical path entering the wavelength converting medium;
employing a solid optical overlay medium that is optically connected to the converter exit surface of the wavelength converting medium, the solid optical overlay medium having at its exit surface damage thresholds at the first and second wavelengths that are greater than the respective damage thresholds of the wavelength converting medium; and
propagating laser radiation at the second wavelength through an exit surface of the solid optical overlay medium.

45. The method of claim 44 in which the solid optical overlay medium and the wavelength converting medium have refractive indices at the second wavelength that have values within two tenths of a point of each other.

46. The method of claim 44 in which the wavelength converting medium comprises AgGaS₂, AgGaSe₂, BBO, BIBO, KTA, KTP, KDP, KD*P/KDP, LiNbO₃, LiLO₃, or LBO.

47. The method of claim 44 in which the solid optical overlay medium comprises fused silica, quartz, undoped YAG, sapphire, ED-2, or ED-4, or E-Y1.

48. The method of claim 44 in which the solid optical overlay medium is diffusion bonded to the wavelength converting medium.

49. The method of claim 44 in which the solid optical overlay medium comprises an overlay exit surface angle at about a Brewster angle and is adapted for propagating radiation at the first and second wavelengths without an antireflective coating.

50. The method of claim 44 in which the second wavelength comprises a second harmonic, third harmonic, fourth harmonic, or fifth harmonic wavelength.

51. The method of claim 44 in which the laser radiation at the second wavelength is employed for micromachining.

52. The method of claim 44 in which the laser radiation at the second wavelength is employed for via drilling or wafer dicing.

53. The method of claim 44 in which the solid optical overlay medium and the wavelength converting medium are mechanically held against each other.

54. The method of claim 44 in which the optical overlay medium comprises an overlay exit surface with an optical coating adapted for propagating the laser radiation at the first and second wavelengths, the coating having damage thresholds at the respective first and second wavelengths that are greater than respective damage thresholds of typical optical coatings applied to the wavelength converting medium.

55. The method of claim 44, further comprising:
employing the converter exit surface angle on an exit surface of the wavelength converting medium to separate laser radiation at the second wavelength from laser radiation at the first wavelength.

56. The method of claim 44, further comprising:
employing an output coupling end mirror to separate laser radiation at the second wavelength from laser radiation at the first wavelength.

57. The method of claim 44 in which the converter exit surface angle is from about a 20 degree angle to a 90 degree angle relative to the axis of the optical path entering the wavelength converting medium.

58. The method of claim 44 in which the solid optical overlay medium comprises an overlay exit surface angle that is about the same as the converter exit surface angle.

59. The method of claim 44 in which the solid optical overlay medium comprises an overlay exit surface angle that is significantly different from the converter exit surface angle.
